(19) United States
(12) Patent Application Publication
(10) Pub. No.: US 2024/0062159 A1
(43) Pub. Date: Feb. 22, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kenichiro WATANABE, Kanagawa (JP)

(73) Assignee: FUJIFILM Business Innovation Corp., Tokyo (JP)

(21) Appl. No.: 18/180,160

(22) Filed: Mar. 8, 2023

(30) Foreign Application Priority Data
Aug. 22, 2022 (JP) 2022-132097

(51) Int. Cl. G06Q 10/10

(52) U.S. Cl. CPC G06Q 10/103

(57) ABSTRACT

An information processing apparatus includes a processor configured to: extract a feature quantity regarding a project; and present a feature quantity that has contributed to a success, as a factor to contribute to a success of a project, the feature quantity that has contributed to the success being a feature quantity identified, with a predetermined method, based on a feature quantity of a past project having a final outcome of success.

### CROSS-REFERENCE TO RELATED APPLICATIONS

This application is based on and claims priority under 35 USC 119 from Japanese Patent Application No. 2022-132097 filed Aug. 22, 2022.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 2005-222174 discloses an activity change background information extraction apparatus. The activity change background information extraction apparatus collects information on individual activities in a series of activities, detects a change in the activities, asks an entity of the activities about the background of the detected change, and identifies the type of a reason that supports the background of the change from an answer to the question. The activity change background information extraction apparatus asks the entity of the activities about an evaluation for the support in accordance with the type of the reason, and generates information on the background of the change on the basis of an answer to the question.

Japanese Unexamined Patent Application Publication No. 2008-276594 discloses an information recommendation apparatus. The information recommendation apparatus automatically retrieves a document suitable for a phase on the basis of which phase of a work process of a user the user is currently in, and displays the retrieved document.

### SUMMARY

A project management system is used to manage the progresses of various projects of software development, sales activities, planning and proposal, and so on. Such projects are considered to be a success if an expected result is obtained but are considered to be a failure if the expected result is not obtained. For example, software development involves various failures such as the inadequate quality of completed software, the occurrence of a delivery delay, and the occurrence of a correction of a function different from the requirement.

Thus, when a project is carried out, preparation is performed in advance to increase the success probability of the project. However, even for a project that has succeeded, it is difficult to uniquely determine which factor has contributed to the success, which performed action led to the success, or which not-performed action led the success.

Aspects of non-limiting embodiments of the present disclosure relate to an information processing apparatus, a non-transitory computer readable medium, and an information processing method capable of grasping a factor to contribute to a success of a project.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: extract a feature quantity regarding a project; and present a feature quantity that has contributed to a success, as a factor to contribute to a success of a project, the feature quantity that has contributed to the success being a feature quantity identified, with a predetermined method, based on a feature quantity of a past project having a final outcome of success.

### BRIEF DESCRIPTION OF THE DRAWINGS

An exemplary embodiment of the present disclosure will be described in detail based on the following figures, wherein:

FIG. 1 illustrates a system configuration of a project management system according to an exemplary embodiment of the present disclosure;

FIG. 2 is a block diagram illustrating a hardware configuration of a project management server according to the exemplary embodiment of the present disclosure;

FIG. 3 is a block diagram illustrating a functional configuration of the project management server according to the exemplary embodiment of the present disclosure;

FIG. 4 is a flowchart for describing a basic operation of the project management server;

FIG. 5 is a flowchart for describing an operation of the project management server in the case of presenting a success factor only for a project with a low success probability;

FIG. 6 is a flowchart for describing an operation of the project management server in the case of presenting a success factor to a user together with information of a specific example of the success factor;

FIG. 7 is a flowchart for describing an operation of the project management server in the case of presenting an alternative to the success factor to a user;

FIG. 8 illustrates an example of a project carried out by a user in charge of planning, a user in charge of development, and a user in charge of sales in cooperation with one another to plan a new product and receive approval from management;

FIG. 9 illustrates an example of information regarding the project illustrated in FIG. 8, stored in a project information database (DB);

FIG. 10 illustrates an example of information that is displayed as a method for increasing a success probability by a project management control unit without limiting users or groups for which the information is displayed;

FIG. 11 illustrates a display example in the case of displaying a warning in a project progress management screen;

FIG. 12 illustrates a display example in the case of displaying a warning in a project progress management screen;

FIG. 13 illustrates a display example in which the use of documents is presented as a success factor in work “Creation of proposal material”; and

FIG. 14 illustrates an example of a display screen displayed in response to a user clicking a displayed link in the display example illustrated in FIG. 13.

### DETAILED DESCRIPTION

An exemplary embodiment of the present disclosure will be described in detail with reference to the accompanying drawings.

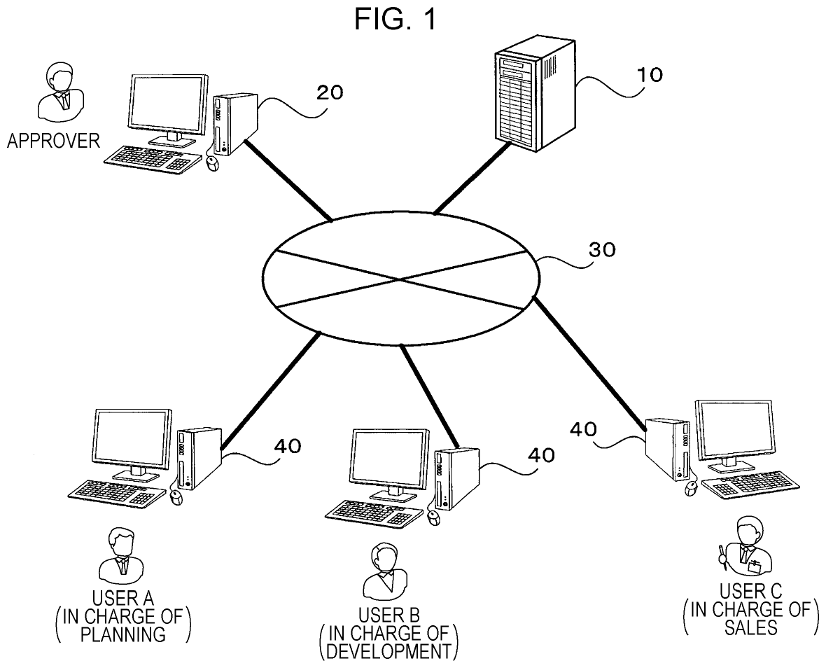

FIG. 1 illustrates a system configuration of a project management system according to an exemplary embodiment of the present disclosure.

As illustrated in FIG. 1, the project management system according to the exemplary embodiment of the present disclosure includes a project management server 10 and terminal apparatuses 20 and 40, which are connected to one another via a network 30. The project management server 10 is an information processing apparatus that manages projects carried out in the past and ongoing projects.

The term “project” refers to work that is performed to achieve a certain purpose by a set deadline. Examples of the projects include various projects such as a development project for developing a certain software system or product, a sales project for receiving an order for a certain product, and a planning project for proposing a certain plan and receiving approval.

Some of such various projects may have a final outcome of success, whereas the others may have a final outcome of failure. For example, a project for developing a software program within a certain period has a final outcome of failure unless the software program is completed within the certain period. Even if the software program is completed within the certain period, the project may have the final outcome of failure because of a reason such as the software program not meeting the requirements specification, the software program having a low product quality, or the like.

In the exemplary embodiment, a planning project in which a group including a user A in charge of planning, a user B in charge of development, and a user C in charge of sales plans a certain product and receives approval from an approver will be described as an example. In such a planning project, each of the users A to C performs activities such as planning, consultation of a plan, and creation of proposal materials via the respective terminal apparatuses 40. The users A to C use various communication tools such as email and business support software such as a web meeting system via the respective terminal apparatuses 40 to exchange messages and information with one another or with external users. The users A to C record activity details and a latest state of the project in the project management server 10 via the respective terminal apparatuses 40. The approver eventually determines whether to approve the proposed plan via the terminal apparatus 20.

When such a project is carried out, preparation is performed in advance to increase a success probability of the project. However, even for a project that has succeeded, it is difficult to uniquely determine which factor contributed to the success, which performed action led to the success, or which not-performed action led the success.

Accordingly, the project management system according to the exemplary embodiment performs a process described below to identify a factor that has contributed to a success from a past project having a final outcome of success and present the identified factor.

The users of the ongoing project adopt the presented success factor of the other project, so that the success probability of the ongoing project increases.

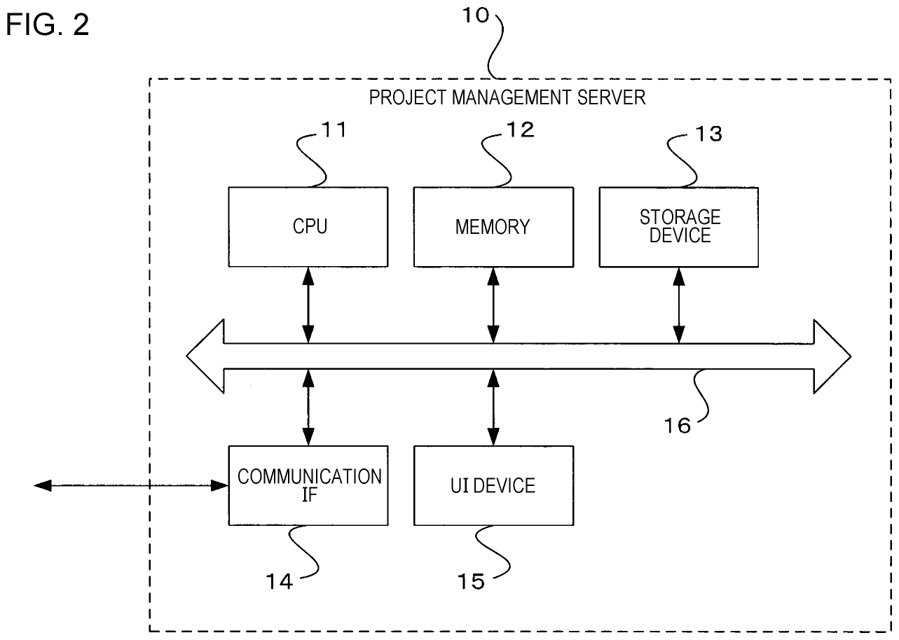

FIG. 2 illustrates a hardware configuration of the project management server 10 of the project management system according to the exemplary embodiment.

As illustrated in FIG. 2, the project management server 10 includes a central processing unit (CPU) 11, a memory 12, a storage device 13 such as a hard disk drive, a communication interface (abbreviated as IF) 14, and a user interface (abbreviated as UI) device 15. The communication IF 14 performs data transmission and reception with an external apparatus or the like via the network 30. The UI device 15 includes a touch panel, or a liquid crystal display and a keyboard. These components are connected to each other via a control bus 16.

The CPU 11 is a processor that performs a predetermined process on the basis of a control program stored in the memory 12 or the storage device 13 to control an operation of the project management server 10. In the exemplary embodiment, the CPU 11 reads and executes the control program stored in the memory 12 or the storage device 13. However, the configuration is not limited to this configuration. This control program may be recorded on a computer-readable recording medium and provided as the computer-readable recording medium. For example, this control program may be recorded on an optical disc such as a compact disc read-only memory (CD-ROM) or a digital versatile disc ROM (DVD-ROM) or in a semiconductor memory such as a Universal Serial Bus (USB) memory or a memory card and provided as such an optical disc or semiconductor memory. This control program may be acquired from an external apparatus via a communication network connected to the communication interface 14.

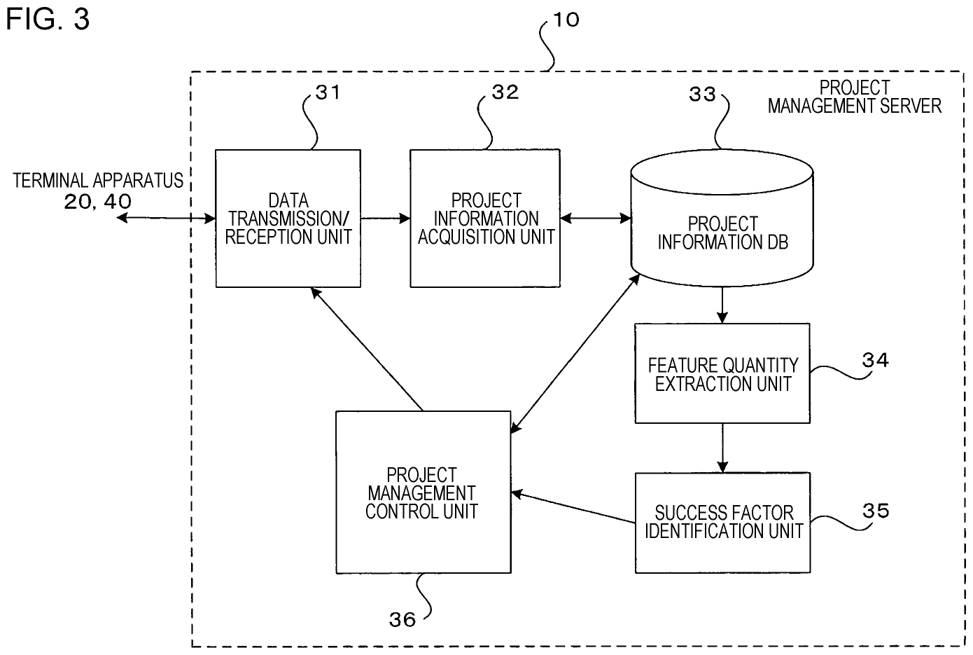

FIG. 3 is a block diagram illustrating a functional configuration of the project management server 10 implemented by execution of the control program.

As illustrated in FIG. 3, the project management server 10 according to the exemplary embodiment includes a data transmission/reception unit 31, a project information acquisition unit 32, a project information DB 33, a feature quantity extraction unit 34, a success factor identification unit 35, and a project management control unit 36.

The data transmission/reception unit 31 transmits and receives data to and from external apparatuses such as the terminal apparatuses 20 and 40.

The project information acquisition unit 32 transmits and receives data to and from the terminal apparatuses 20 and 40 via the data transmission/reception unit 31 to acquire various kinds of information regarding a project. Specifically, from message information transmitted and received via business support software that enables communication among plural users, the project information acquisition unit 32 acquires information on measures taken to make the project progress, information on an action performed by a user to make the project progress, or information on a medium such as a material that has been used.

The project information DB 33 stores the various kinds of information regarding the project acquired by the project information acquisition unit 32.

The feature quantity extraction unit 34 extracts a feature quantity regarding a past project having a final outcome of success from the various kinds of information regarding the project stored in the project information DB 33.

For example, the feature quantity extraction unit 34 extracts, as the feature quantity regarding the project, at least one of the information on measures taken to make the project progress, information on an action performed by a user to make the project progress, information on a medium that has been used, information on a user participating in the project, or information on business support software in use.

The success factor identification unit 35 identifies, with a predetermined method, a feature quantity that has contributed to a success of the project from among the feature quantities extracted by the feature quantity extraction unit 34.

The project management control unit 36 presents, to a user, the feature quantity identified by the success factor identification unit 35, as a factor to contribute to a success of a project. That is, the project management control unit 36 presents, as a factor to contribute to a success of a project, a feature quantity that has contributed to a success and is identified, with a predetermined method, based on a feature quantity of a past project having a final outcome of success.

Specific description will be given of the predetermined method that is used when the success factor identification unit 35 identifies a feature quantity that has contributed to a success of a certain project from among feature quantities of the certain project extracted by the feature quantity extraction unit 34.

(1) One example method of the predetermined method used by the success factor identification unit 35 is a method of identifying a feature quantity to contribute to a success of a project through analysis a prediction model that is generated by machine learning performed in advance using, as training data, the feature quantity of the past project having the final outcome of success and the final outcome of success.

Note that the prediction model may be generated by the machine learning performed using, as the training data, a feature quantity of a past project having a final outcome of failure in addition to the feature quantity of the past project having the final outcome of success.

(2) Another example method of the predetermined method used by the success factor identification unit 35 is a method of identifying a feature quantity to contribute to a success of a project through analysis of feature quantities of plural past projects having a final outcome of success with a statistical technique.

Specifically, the success factor identification unit 35 identifies the feature quantity to contribute to the success of the project, based on frequencies of the respective feature quantities in the plural past projects having the final outcome of success or magnitudes of values of a correlation coefficient between the final outcome of each of the plural past projects and the presence of each of the feature quantities.

Note that the success factor identification unit 35 may identify a single feature quantity having a largest degree of contribution to a success of a project, as the feature quantity that has contributed to the success.

Alternatively, the success factor identification unit 35 may identify one or more feature quantities having a degree of contribution to a success of a project greater than a preset value, as the feature quantity that has contributed to the success.

The project management control unit 36 may present, only for a project for which a prediction result indicating a failure is obtained with the generated prediction model, the factor to contribute to the success of the project, rather than presenting the factor to contribute to the success for all ongoing projects.

The project information acquisition unit 32 may acquire specific information corresponding to the feature quantity identified as having contributed to the success, from information of the past project, and the project management control unit 36 may present the acquired specific information together with the factor to contribute to the success of the project.

For example, if the factor that has contributed to a success is the use of a certain material in presentation, the project information acquisition unit 32 acquires information of the certain material and the project management control unit 36 presents the information of the certain material together with the factor to contribute to the success of the project to the user.

The proposed factor to contribute to the success of the project may be unfeasible for the user who receives the proposal.

Accordingly, the project information acquisition unit 32 may acquire user information of a project that is to be or is being carried out, and if the factor to contribute to the success of the project is unfeasible for a user to whom the factor is to be presented, the project management control unit 36 may present an alternative that is feasible for the user.

For example, description will be given of a case where participation of a user C in the project is known to increase the success probability but the participation of the user C in the project is unfeasible because the user to whom the success factor is to be presented is not acquainted with the user C or the user C is hectic, has been transferred to another section, or has retired. In this case, the project management control unit 36 searches for another user having a skill similar to that of the user C, and proposes the other user's participation in the project.

The project management control unit 36 determines, for a past project of which the information is stored in the project information DB 33, whether the project completed in the past is a success or a failure on the basis of a preset condition.

For example, in the case of a project intended to receive an order for a certain product, the project management control unit 36 determines that the project has a final outcome of success if the order for the certain product is received and determines that the project has a final outcome of failure if no order for the product is received.

Operations of the project management server 10 in the exemplary embodiment will be described in detail with reference to the accompanying drawings.

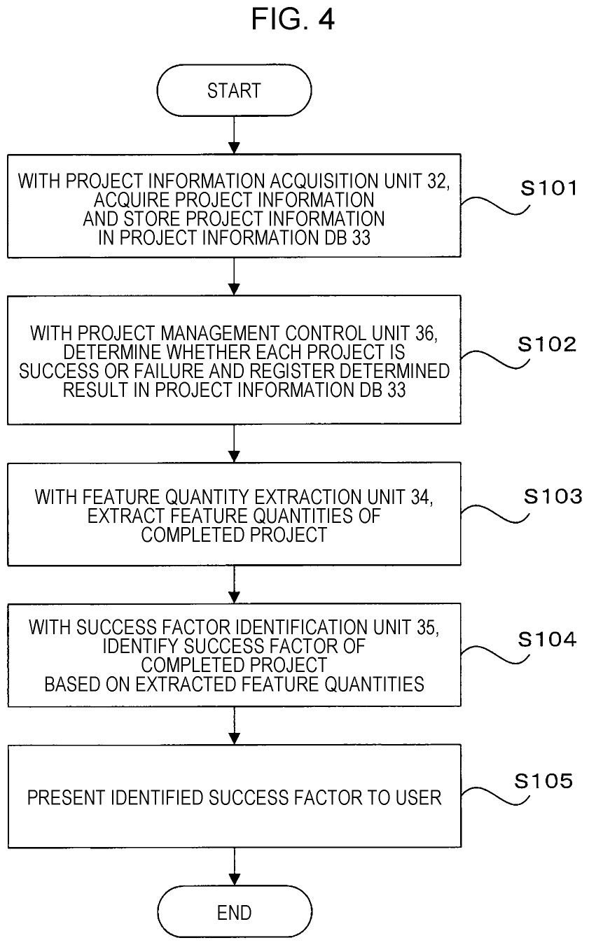

A basic operation of the project management server 10 will be described with reference to a flowchart of FIG. 4.

In step S101, the project information acquisition unit 32 acquires information regarding each project via the data transmission/reception unit 31 and stores the information in the project information DB 33.

In step S102, the project management control unit 36 determines whether each project registered in the project information DB 33 is a success or a failure, and registers the determined result in the project information DB 33.

In step S103, the feature quantity extraction unit 34 extracts feature quantities of each completed project on the basis of the information regarding the project.

In step S104, the success factor identification unit 35 identifies a success factor of each completed project on the basis of the feature quantities extracted by the feature quantity extraction unit 34.

In step S105, the project management control unit 36 presents the success factor identified by the success factor identification unit 35 to a user.

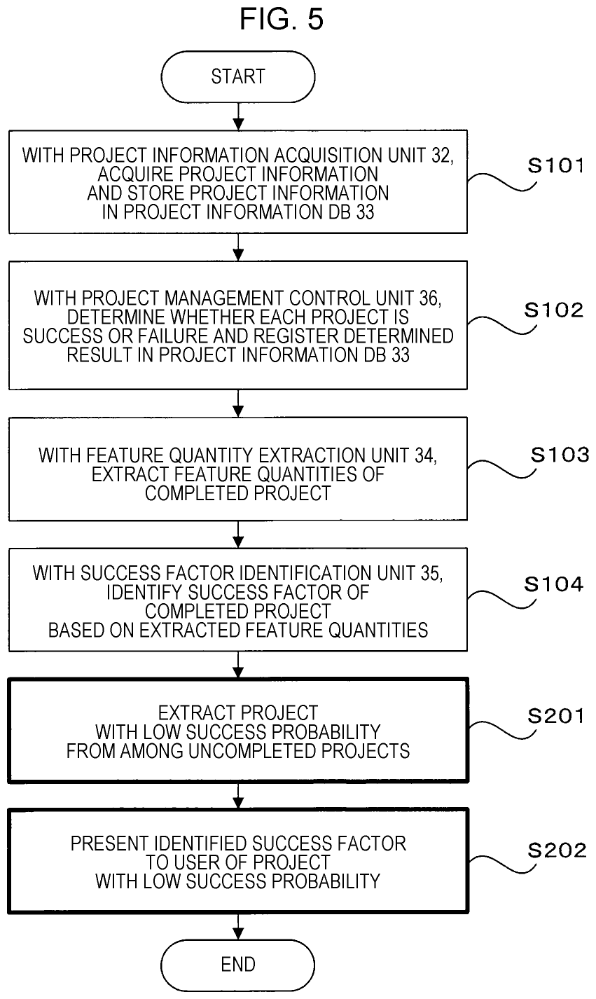

An operation performed when the project management server 10 presents the success factor of a past project only for a project with a low success probability, rather than presenting the success factor for all the ongoing projects will be described with reference to a flowchart of FIG. 5.

The flowchart of FIG. 5 is different from the flowchart of FIG. 4 in that the processing of step S105 is replaced with processing of steps S201 and S202. Thus, the processing of steps S201 and S202 newly added in FIG. 5 will be described.

In step S201, the project management control unit 36 uses the prediction model described above to predict whether each of ongoing uncompleted projects is to eventually succeed or fail. The project management control unit 36 extracts a project with a success probability that is lower than a certain set value from among the uncompleted projects.

In step S202, the project management control unit 36 presents the success factor identified by the success factor identification unit 35 to a user of the project with a low success possibility.

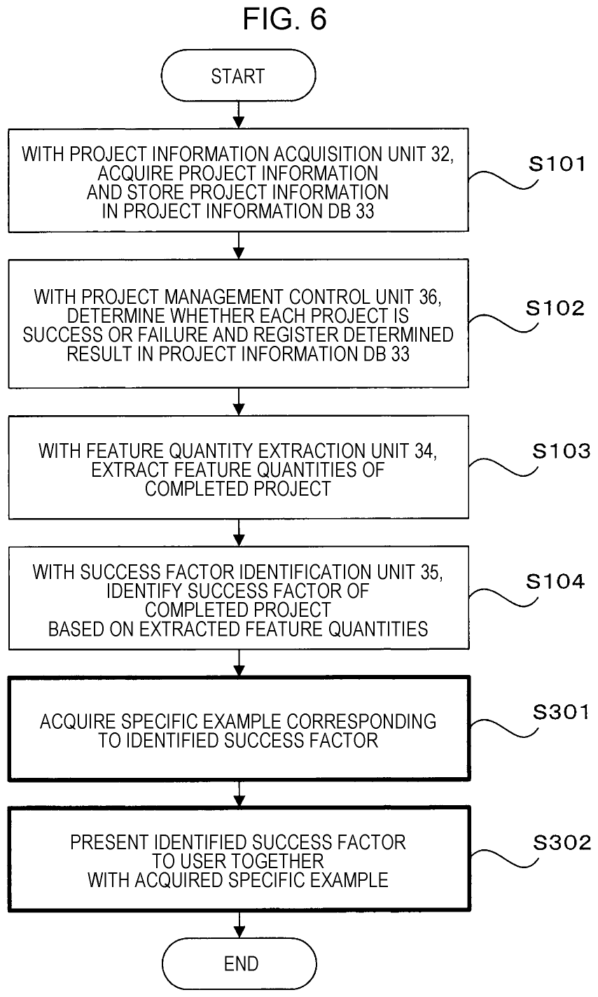

An operation performed when the project management server 10 presents the success factor to a user together with information of a specific example of the success factor will be described with reference to a flowchart of FIG. 6.

The flowchart of FIG. 6 is different from the flowchart of FIG. 4 in that the processing of step S105 is replaced with processing of steps S301 and S302. Thus, the processing of steps S301 and S302 newly added in FIG. 6 will be described.

In step S301, the project information acquisition unit 32 acquires a specific example corresponding to the success factor identified by the success factor identification unit 35.

In step S302, the project management control unit 36 presents the success factor identified by the success factor identification unit 35 to a user together with the information of the specific example acquired by the project information acquisition unit 32.

For example, when the use of a certain guideline, material, or the like is identified to be a success factor, deliverables and a list of communication histories based on the certain guideline, material, or the like are presented to the user together with the success factor.

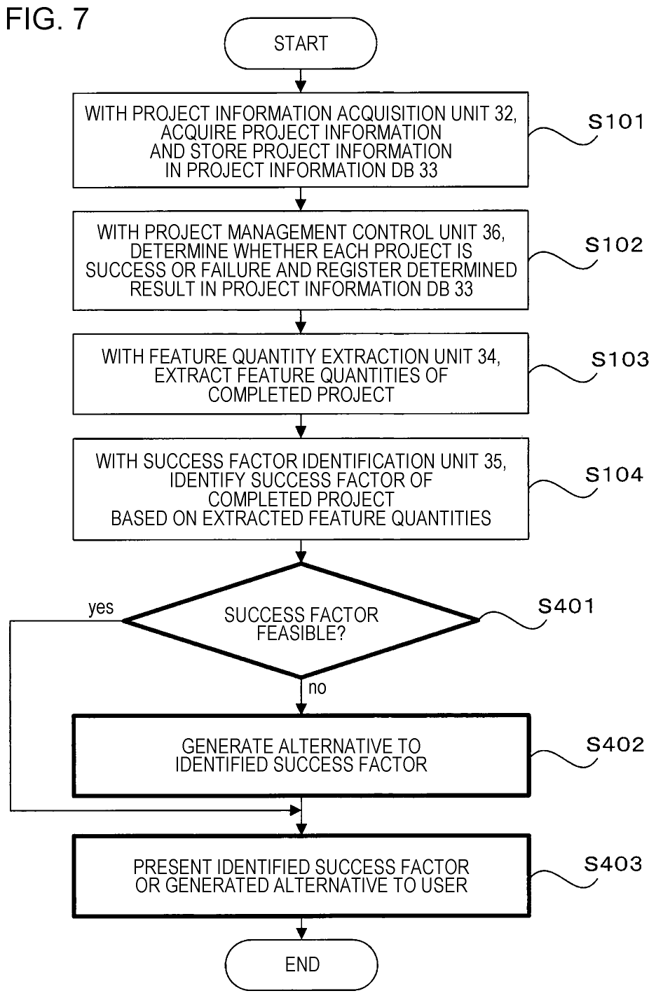

An operation performed when the project management server 10 presents an alternative to the success factor to a user will be described with reference to a flowchart of FIG. 7.

The flowchart of FIG. 7 is different from the flowchart of FIG. 4 in that the processing of step S105 is replaced with processing of steps S401 to S403. Thus, the processing of steps S401 to S403 newly added in FIG. 7 will be described.

In step S401, the project management control unit 36 determines whether the success factor identified by the success factor identification unit 35 is feasible for a user to whom the success factor is to be proposed.

If the project management control unit 36 determines in step S401 that the success factor identified by the success factor identification unit 35 is feasible for the user to whom the success factor is to be proposed, the project management control unit 36 presents the identified success factor to the user in step S403.

If the project management control unit 36 determines in step S401 that the success factor identified by the success factor identification unit 35 is unfeasible for the user to whom the success factor is to be proposed, the project management control unit 36 generates an alternative to the identified success factor in step S402.

In step S403, the project management control unit 36 presents the generated alternative to the user as a success factor for increasing the success probability of the project.

For example, if participation of a certain user in a project increases the success probability of the project but participation of the certain user is unfeasible, the project management control unit 36 presents participation of another user having a skill equivalent to the skill of the certain user as the success factor.

What kind of information is extracted as a feature quantity with the progress of a project will be described with reference to a specific project.

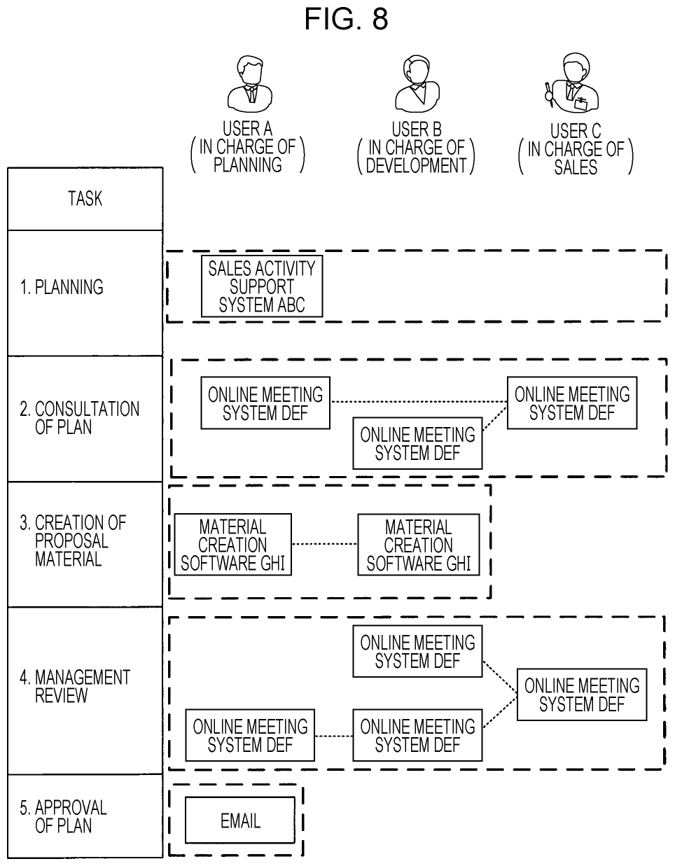

FIG. 8 illustrates an example of a project carried out by the user A in charge of planning, the user B in charge of development, and the user C in charge of sales in cooperation with one another to plan a new product and receive approval from management.

This project proceeds in steps below.

(1) The user A in charge of planning analyzes data of a sales activity support system ABC and drafts an idea for a new product.

(2) The user A in charge of planning, the user B in charge of development, and the user C in charge of sales use an online meeting system DEF to brush up the idea of the user A into a feasible idea from the viewpoint of development and sales.

(3) The user A in charge of planning and the user B in charge of development use material creation software GHI to create a proposal draft. The users A and B create the proposal draft while obtaining a confirmation from the user C in charge of sales as appropriate.

(4) The users A, B, and C use the online meeting system DEF to explain the proposal draft to management.

(5) Lastly, the user A makes a request for approval by email, and receives approval for the planned new product by email.

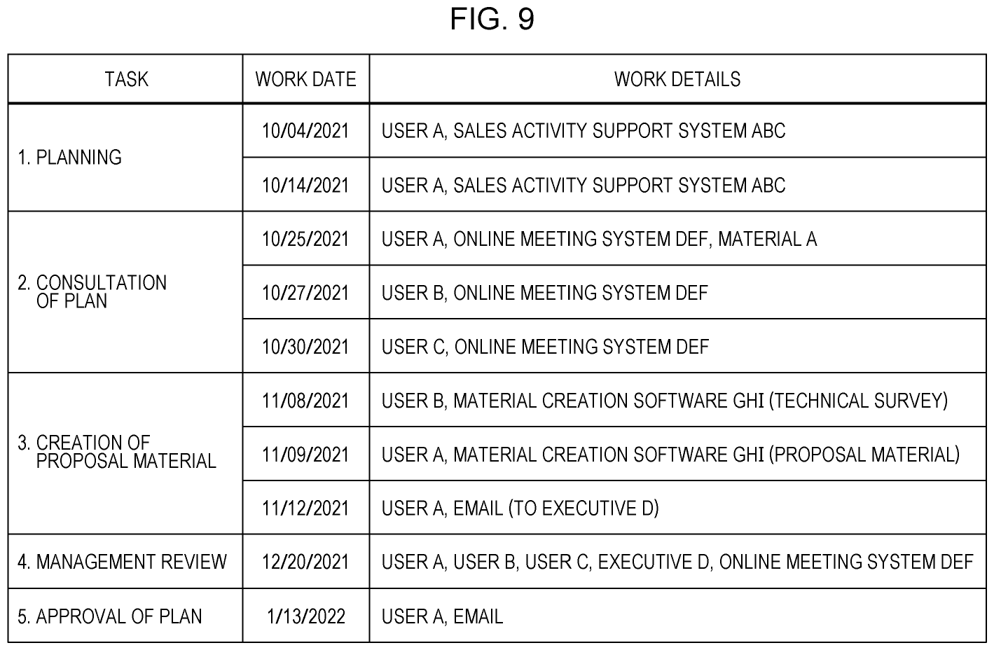

In the project management server 10, various kinds of information such as a work history and actual results of the project are stored in the project information DB 33. FIG. 9 illustrates an example of information regarding the project illustrated in FIG. 8, stored in the project information DB 33.

FIG. 9 indicates that information such as a name of each task of the project, a work date (or work date and time), and work details is stored. In the case of such a project, training data is created by determining that the final outcome of the project is a success if approval is obtained for the planned new product and determining that the final outcome of the project is a failure if approval is not obtained for the planned new product.

When the final outcome of the project is a success, for example, the project management server 10 can detect that there is a high correlation between the utilization of the sales activity support system ABC and approval for the proposed plan, and extract a success factor indicating that the use of the sales activity support system ABC enables creation of a data-based plan and thus leads to a high approval rate.

For example, the project management server 10 can extract a success factor indicating that the utilization of a material A leads to a high approval rate.

For example, the project management server 10 can extract a success factor indicating that adoption of an opinion of the user C in charge of sales leads to a high approval rate.

For example, the project management server 10 can extract a success factor indicating that the completion of a technical survey before the management review by a predetermined number of days or more leads to a high approval rate, on the basis of a difference between the date and time of the management review and the date and time of the technical survey.

For example, since the proposal material is sent to an executive D before the management review, the project management server 10 can extract a success factor indicating that a prior contact with an executive leads to a high approval rate.

In addition to the foregoing, the project management server 10 can present an effective use period on the basis of a correlation between a use period of a certain system and a success/failure of a project. For example, if a fact that the use of the system for a certain period leads to a high success probability but the use of the system beyond the certain period does not lead to a further increase in the success probability is determined, the project management server 10 can present an optimum use period of the system.

If a skill or capability of each user participating in the project and the use of which system by the user to participate in the project leads to an increase in the success probability are determined, the project management server 10 can present information indicating that participation of a user having which skill or capability via which system leads to an increase in the success probability.

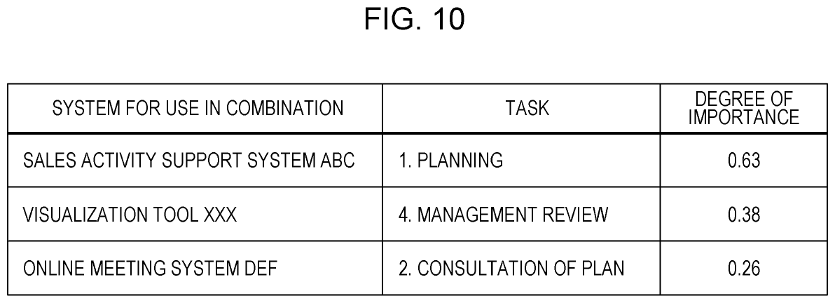

FIGS. 10 to 14 illustrate specific display examples used when the project management control unit 36 presents a success factor to a user.

For example, the project management control unit 36 displays, as a method for increasing the success probability, information illustrated in FIG. 10 without limiting users or groups for which the information is displayed.

For example, the project management control unit 36 can employ various display methods such as displaying the information at a portal site, displaying the information at the start of a project of the same type, and displaying the information by setting a link to the information while the project is being carried out.

The display example of FIG. 10 indicates that the use of the “sales activity support system ABC” in the “planning” work is most effective in terms of the purpose of receiving approval. The degree of importance can take various values depending on a method of identifying a success factor carried out by the success factor identification unit 35.

Specifically, when the success factor identification unit 35 uses a statistical technique to identify the success factor, a correlation coefficient or an occurrence frequency in projects having a final outcome of success can be used as the degree of importance. When the success factor identification unit 35 uses a prediction model to identify the success factor, a value of a degree of importance in a result of machine learning can be used.

The project management control unit 36 may display the success factor only to a user of a project for which the success probability is predicted to be low at the present time point after the work has progressed to some extent, rather than presenting the success factor to all users or groups.

Specifically, the project management control unit 36 may display a warning in a project progress management screen or notifies the user using a communication tool such as email to cause the screen to transition to a warning screen via link information included in the notification.

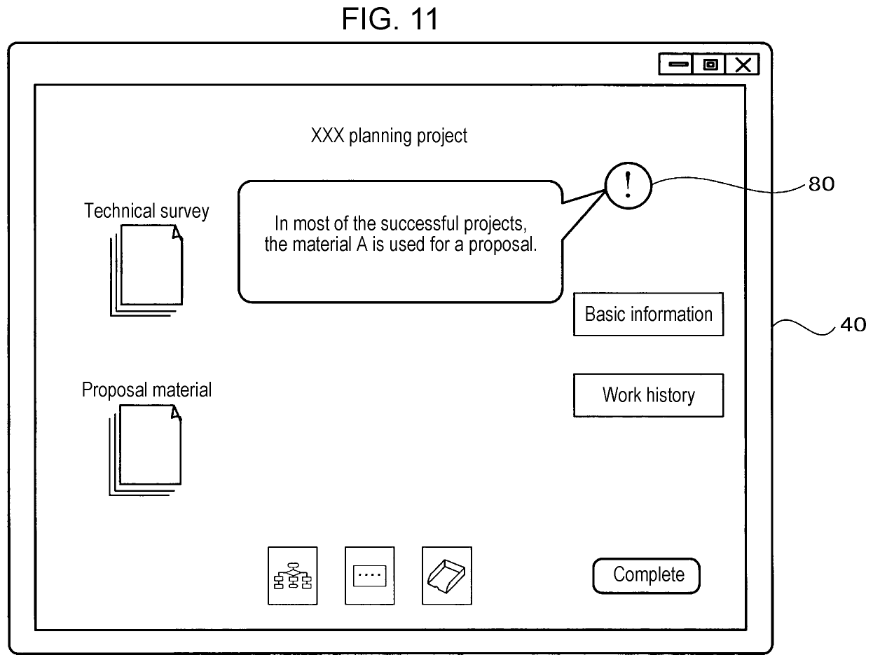

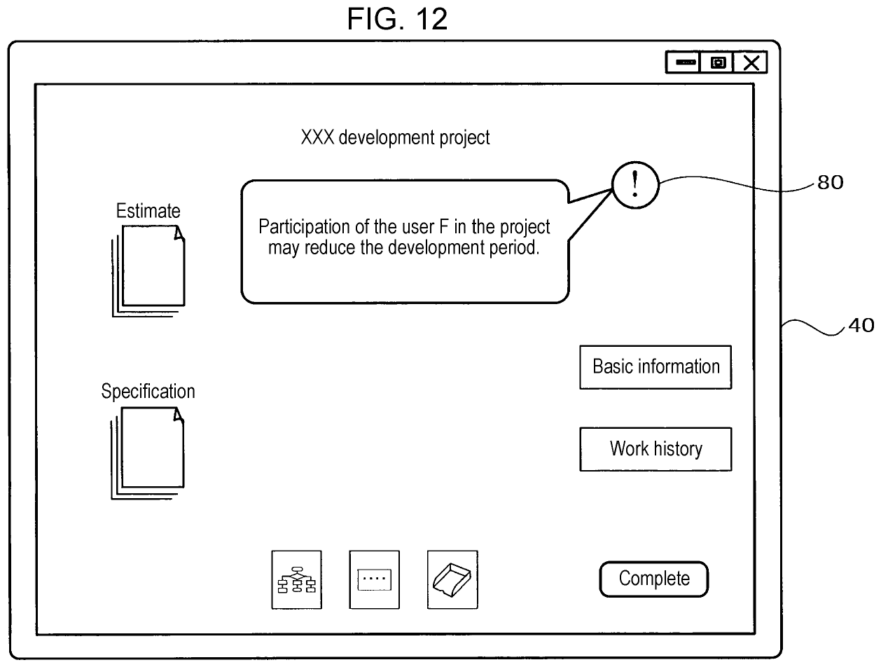

FIGS. 11 and 12 illustrate display examples used when a warning is displayed in a project progress management screen.

In FIG. 11, a warning 80 is displayed in a project progress management screen of a XXX planning project, and a proposal for increasing the success probability “In most of the successful projects, the material A is used to make a proposal.” is made.

In FIG. 12, the warning 80 is displayed in a progress management screen of a XXX development project, and a proposal “Participation of the user F in the project may reduce the development period.” is made.

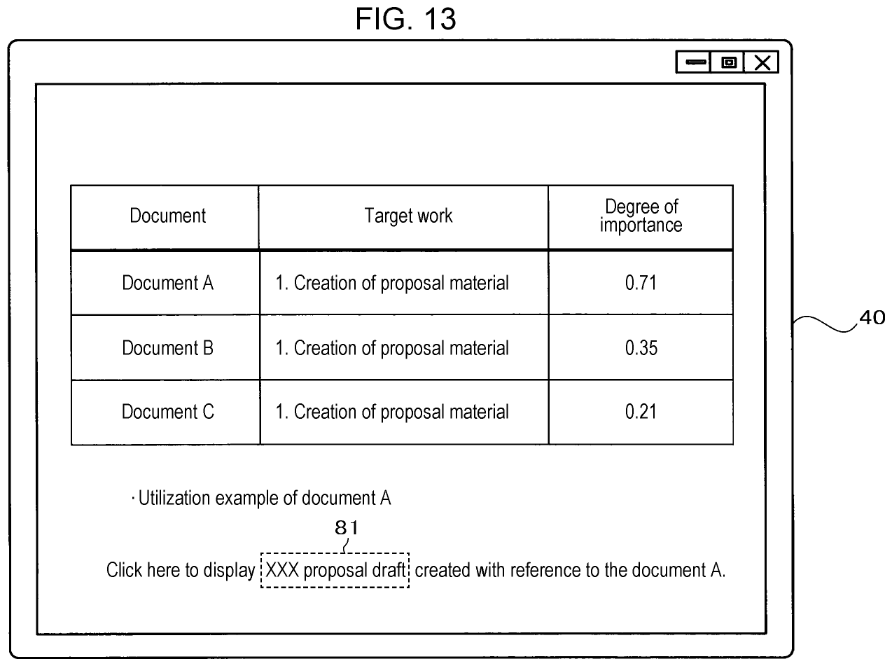

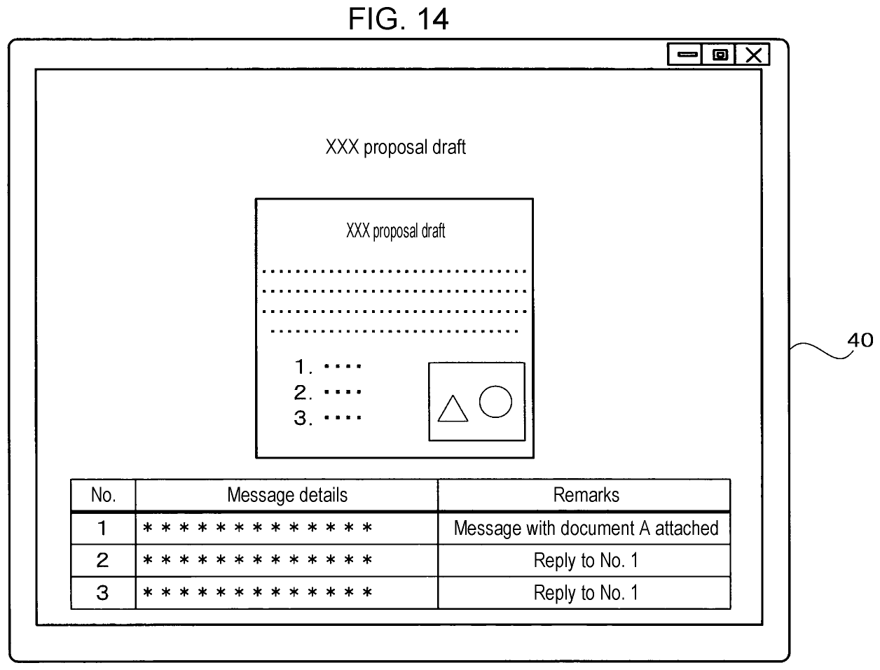

FIGS. 13 and 14 illustrate display examples used when information of a specific example is presented together with the success factor.

In FIG. 13, information indicating that the use of documents A, B, and C is a success factor in the work “creation of proposal material” is presented. The document A has the highest degree of importance and a link 81 for the “XXX proposal draft” created with reference to the document A is displayed as a utilization example of the document A.

FIG. 14 illustrates an example of a display screen displayed in response to the user clicking the displayed link 81. In the example of the display screen illustrated in FIG. 14, a list of communications performed using the document A is displayed together with specific contents of the “XXX proposal draft”.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   extract a feature quantity regarding a project; and
   present a feature quantity that has contributed to a success, as a factor to contribute to a success of a project, the feature quantity that has contributed to the success being a feature quantity identified, with a predetermined method, based on a feature quantity of a past project having a final outcome of success.
      (((2)))

The information processing apparatus according to (((1))), wherein the predetermined method comprises a method of identifying a feature quantity to contribute to a success of a project through analysis of a prediction model that is generated by machine learning performed in advance using, as training data, the feature quantity of the past project having the final outcome of success and the final outcome of success.

(((3)))

The information processing apparatus according to (((2))), wherein the prediction model is generated by the machine learning performed using, as the training data, a feature quantity of a past project having a final outcome of failure in addition to the feature quantity of the past project having the final outcome of success.

(((4)))

The information processing apparatus according to (((1))), wherein:
the past project is one of a plurality of past projects having a final outcome of success; and
the predetermined method comprises a method of identifying a feature quantity to contribute to a success of a project through analysis of feature quantities of the plurality of past projects with a statistical technique.
   (((5)))

The information processing apparatus according to (((4))), wherein the processor is configured to identify the feature quantity to contribute to the success of the project, based on frequencies of the respective feature quantities in the plurality of past projects having the final outcome of success or magnitudes of values of a correlation coefficient between the final outcome of each of the plurality of past projects and presence of each of the feature quantities.

(((6)))

The information processing apparatus according to any one of (((1))) to (((5))), wherein the processor is configured to identify a single feature quantity having a largest degree of contribution to a success of a project, as the feature quantity that has contributed to the success.

(((7)))

The information processing apparatus according to any one of (((1))) to (((5))), wherein the processor is configured to identify one or more feature quantities having a degree of contribution to a success of a project greater than a preset value, as the feature quantity that has contributed to the success.

(((8)))

The information processing apparatus according to (((2))) or (((3))), wherein the processor is configured to present, only for a project for which a prediction result indicating a failure is obtained with the generated prediction model, the factor to contribute to the success of the project.

(((9)))

The information processing apparatus according to any one of (((1))) to (((8))), wherein the processor is configured to:
acquire specific information corresponding to the feature quantity identified as having contributed to the success, from information of the past project; and
present the specific information together with the factor to contribute to the success of the project.
   (((10)))

The information processing apparatus according to any one of (((1))) to (((9))), wherein the processor is configured to:
acquire user information of a project that is to be or is being carried out; and
present, in a case where the factor to contribute to the success of the project is unfeasible for a user to whom the factor is to be presented, an alternative that is feasible for the user.
   (((11)))

The information processing apparatus according to any one of (((1))) to (((10))), wherein the processor is configured to extract, as the feature quantity regarding the project, at least one of information on measures taken to make the project progress, information on an action performed by a user to make the project progress, information on a medium that has been used, information on a user participating in the project, or information on business support software in use.

(((12)))

The information processing apparatus according to any one of (((1))) to (((11))), wherein the processor is configured to determine whether a project completed in past is a failure or a success, based on a preset condition.

(((13)))

A program causing a computer to perform a process, the process comprising:
extracting a feature quantity regarding a project; and
presenting a feature quantity that has contributed to a success, as a factor to contribute to a success of a project, the feature quantity that has contributed to the success being a feature quantity identified, with a predetermined method, based on a feature quantity of a past project having a final outcome of success.

What is claimed is:

1. An information processing apparatus comprising:
a processor configured to:
extract a feature quantity regarding a project; and
present a feature quantity that has contributed to a success, as a factor to contribute to a success of a project, the feature quantity that has contributed to the success being a feature quantity identified, with a predetermined method, based on a feature quantity of a past project having a final outcome of success.

2. The information processing apparatus according to claim 1, wherein the predetermined method comprises a method of identifying a feature quantity to contribute to a success of a project through analysis of a prediction model that is generated by machine learning performed in advance using, as training data, the feature quantity of the past project having the final outcome of success and the final outcome of success.

3. The information processing apparatus according to claim 2, wherein the prediction model is generated by the machine learning performed using, as the training data, a feature quantity of a past project having a final outcome of failure in addition to the feature quantity of the past project having the final outcome of success.

4. The information processing apparatus according to claim 1, wherein:
the past project is one of a plurality of past projects having a final outcome of success; and
the predetermined method comprises a method of identifying a feature quantity to contribute to a success of a project through analysis of feature quantities of the plurality of past projects with a statistical technique.

5. The information processing apparatus according to claim 4, wherein the processor is configured to identify the feature quantity to contribute to the success of the project, based on frequencies of the respective feature quantities in the plurality of past projects having the final outcome of success or magnitudes of values of a correlation coefficient between the final outcome of each of the plurality of past projects and presence of each of the feature quantities.

6. The information processing apparatus according to claim 1, wherein the processor is configured to identify a single feature quantity having a largest degree of contribution to a success of a project, as the feature quantity that has contributed to the success.

7. The information processing apparatus according to claim 1, wherein the processor is configured to identify one or more feature quantities having a degree of contribution to a success of a project greater than a preset value, as the feature quantity that has contributed to the success.

8. The information processing apparatus according to claim 2, wherein the processor is configured to present, only for a project for which a prediction result indicating a failure is obtained with the generated prediction model, the factor to contribute to the success of the project.

9. The information processing apparatus according to claim 1, wherein the processor is configured to:
acquire specific information corresponding to the feature quantity identified as having contributed to the success, from information of the past project; and
present the specific information together with the factor to contribute to the success of the project.

10. The information processing apparatus according to claim 1, wherein the processor is configured to:
acquire user information of a project that is to be or is being carried out; and
present, in a case where the factor to contribute to the success of the project is unfeasible for a user to whom the factor is to be presented, an alternative that is feasible for the user.

11. The information processing apparatus according to claim 1, wherein the processor is configured to extract, as the feature quantity regarding the project, at least one of information on measures taken to make the project progress, information on an action performed by a user to make the project progress, information on a medium that has been used, information on a user participating in the project, or information on business support software in use.

12. The information processing apparatus according to claim 1, wherein the processor is configured to determine whether a project completed in past is a failure or a success, based on a preset condition.

13. A non-transitory computer readable medium storing a program causing a computer to execute a process, the process comprising:
extracting a feature quantity regarding a project; and
presenting a feature quantity that has contributed to a success, as a factor to contribute to a success of a project, the feature quantity that has contributed to the success being a feature quantity identified, with a predetermined method, based on a feature quantity of a past project having a final outcome of success.

14. An information processing method comprising:
extracting a feature quantity regarding a project; and
presenting a feature quantity that has contributed to a success, as a factor to contribute to a success of a project, the feature quantity that has contributed to the success being a feature quantity identified, with a predetermined method, based on a feature quantity of a past project having a final outcome of success.
